(19) United States
(12) Patent Application Publication
(10) Pub. No.: US 2011/0178880 A1
(43) Pub. Date: Jul. 21, 2011

(54) SYSTEM AND METHOD FOR MONITORING AND REPORTING PRESENTATION OF RECORDED ADVERTISING CONTENT

(76) Inventors: Jeyhan Karaoguz, Irvine, CA (US); Nambirajan Seshadri, Irvine, CA (US); Henry Samueli, Corona Del Mar, CA (US)

(21) Appl. No.: 12/948,975

(22) Filed: Nov. 18, 2010

Related U.S. Application Data
(60) Provisional application No. 61/295,332, filed on Jan. 15, 2010.

(51) Int. Cl. G06Q 30/00

(52) U.S. Cl. 705/14.73

(57) ABSTRACT

A system and method for monitoring and reporting presentation of recorded advertising content, substantially as shown in and/or described in connection with at least one of the figures, as set forth more completely in the claims.

### CROSS-REFERENCE TO RELATED APPLICATIONS/INCORPORATION BY REFERENCE

This patent application is related to and claims priority from provisional patent application Ser. No. 61/295,332 filed Jan. 15, 2010, and titled “SYSTEM AND METHOD FOR MONITORING AND REPORTING PRESENTATION OF RECORDED ADVERTISING CONTENT,” the contents of which are hereby incorporated herein by reference in their entirety. This patent application is also related to U.S. patent application Ser. No. ______, filed concurrently herewith, titled “SYSTEM AND METHOD IN A PROGRAM RECORDER FOR MANAGING ADVERTISEMENT PRESENTATION”, Attorney Docket No. 21194US02; U.S. patent application Ser. No. ______, filed concurrently herewith, titled “SYSTEM AND METHOD FOR UPDATING ADVERTISING CONTENT FOR A RECORDED PROGRAM”, Attorney Docket No. 21195US02; U.S. patent application Ser. No. ______, filed concurrently herewith, titled “SYSTEM AND METHOD FOR PROVIDING USER SPECIFICATION OF ADVERTISING CONTENT”, Attorney Docket No. 21196US02; U.S. patent application Ser. No. ______, filed concurrently herewith, titled “SYSTEM AND METHOD FOR PROVIDING VIEWER IDENTIFICATION-BASED ADVERTISING”, Attorney Docket No. 21198US02; and U.S. patent application Ser. No. ______, filed concurrently herewith, titled “SYSTEM AND METHOD FOR COMMUNICATING PROGRAMMING AND ADVERTISING CONTENT THROUGH DIVERSE COMMUNICATION NETWORKS”, Attorney Docket No. 21199US02. The contents of each of the above-mentioned applications are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Users generally have the ability to skip or view recorded advertising content. Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for monitoring and reporting presentation of recorded advertising content. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 shows a non-limiting exemplary flow diagram of a method for monitoring and reporting presentation of recorded advertising content, in accordance with various aspects of the present invention.

FIG. 2 shows a non-limiting exemplary flow diagram of a method for monitoring and reporting presentation of recorded advertising content, in accordance with various aspects of the present invention.

FIG. 3 is a diagram illustrating an exemplary video content distribution and presentation reporting environment.

FIG. 4 is a diagram illustrating various non-limiting aspects of exemplary user equipment, in accordance with various aspects of the present invention.

FIG. 5 is a diagram illustrating exemplary modules and/or sub-modules for user equipment, in accordance with various aspects of the present invention.

### DETAILED DESCRIPTION OF VARIOUS ASPECTS OF THE INVENTION

The following discussion will refer to various communication modules, components or circuits. Such modules, components or circuits may generally comprise hardware and/or a combination of hardware and software (e.g., including firmware). Such modules may also, for example, comprise a computer readable medium (e.g., a non-transitory medium) comprising instructions (e.g., software instructions) that, when executed by a processor, cause the processor to perform various functional aspects of the present invention. Accordingly, the scope of various aspects of the present invention should not be limited by characteristics of particular hardware and/or software implementations of a module, component or circuit unless explicitly claimed as such. For example and without limitation, various aspects of the present invention may be implemented by one or more processors (e.g., a microprocessor, digital signal processor, baseband processor, microcontroller, etc.) executing software instructions (e.g., stored in volatile and/or non-volatile memory). Also for example, various aspects of the present invention may be implemented by an application-specific integrated circuit (“ASIC”) and/or other hardware components.

Additionally, the following discussion will refer to various system modules (e.g., user equipment modules). It should be noted that the following discussion of such various modules is segmented into such modules for the sake of illustrative clarity. However, in actual implementation, the boundaries between various modules may be blurred. For example, any or all of the functional modules discussed herein may share various hardware and/or software components. For example, any or all of the functional modules discussed herein may be implemented wholly or in-part by a shared processor executing software instructions. Additionally, various software sub-modules that may be executed by one or more processors may be shared between various software modules. Accordingly, the scope of various aspects of the present invention should not be limited by arbitrary boundaries between various hardware and/or software components, unless explicitly claimed.

The following discussion may also refer to communication networks and various aspects thereof. For the following discussion, a communication network is generally the communication infrastructure through which a communication device (e.g., a video recorder, a personal video recorder, an electronic device with video recording capability, a television receiver, a television, a television controller, a portable communication device, a video content provider, a television program provider, an advertising video provider, a data network communication service provider, etc.) may communicate with other systems. For example and without limitation, a communication network may comprise a cable and/or satellite television communication network, a cellular communication network, a telecommunication network, a general data communication network (e.g., the Internet) a wireless metropolitan area network (WMAN), a wireless local area network (WLAN), a wireless personal area network (WPAN), any home or premises communication network, etc. A particular communication network may, for example, generally have a corresponding communication protocol according to which a device (e.g., user equipment comprising an electronic device with video recording and/or monitoring capability) may communicate with the communication network. Unless so claimed, the scope of various aspects of the present invention should not be limited by characteristics of a particular type of communication network and/or communication protocol.

Additionally, the following discussion will at times refer to media content. Such media content may, for example, comprise various types of television and/or radio programming (e.g., television programs, news programs, sports programs, music television, movies, television series programs and/or embedded advertisements, educational programs, live or recorded television programming, broadcast/multicast/unicast television programming, radio programs, etc.). Such media content may, for example, comprise real-time broadcast programming (or multicast or unicast programming) and/or user-stored programming that is stored in user equipment (e.g., a VCR, PVR, etc.). Such media content may also, for example, comprise advertising content (e.g., an audio/video television or radio commercial, a still image advertisement, a user-interactive advertisement, advertising content embedded in and/or separate from programming content, etc.). Such media content may also, for example, comprise graphical and/or textual content that may be displayed on a television (or video display) screen (e.g., an electronic program guide, user interface menu, a television set-up menu, a typical web page, a document, a graphical video game, etc.).

Various aspects of the present invention may, for example in user equipment (e.g., a personal electronic device or system comprising video recording capability), comprise receiving and recording advertising content (e.g., embedded in programming content, separate from programming content, etc.), monitoring playback of such recorded advertising content, and reporting information regarding the monitored playback (e.g., to an advertising content source, to any commercial entity concerned with the presentation of recorded advertising content, etc.).

As will be discussed in more detail below, in a non-limiting exemplary scenario, user equipment (e.g., a stand-alone video recorder, set-top box with video recording capability, video gaming device with video recording capability, a personal computing system with video recording capability, etc.) may be used to record and time-shift the presentation of a media program. The media program may have advertisements (e.g., video and/or audio commercials) associated with the media program (e.g., embedded in the media program or otherwise associated with the media program). A user may, however, choose to skip advertising content by, for example, utilizing skip functionality, fast-forward trick play functionality, etc. Alternatively, a user may choose to play back advertising content (e.g., a video commercial) in which the user has interest (e.g., entertainment interest, interest in a particular good and/or service being advertised, etc.).

In such a scenario, in which a recorded advertisement is played back or skipped, a provider of such advertising content (e.g., a network programming provider, a communication network provider, an advertising agency, a provider in goods and/or services being advertised, etc.) is generally unaware of whether such advertising content is reaching the target audience. Various aspects of the present invention may, for example, be utilized to inform a provider of advertising content (or other interested party) of whether such recorded advertising content is ultimately being provided to an end user.

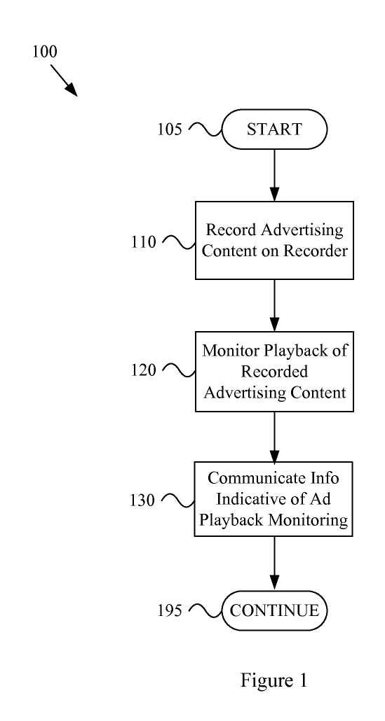

FIG. 1 shows a non-limiting exemplary flow diagram of a method 100 for monitoring and reporting presentation of recorded advertising content, in accordance with various aspects of the present invention. Any or all aspects of the exemplary method 100 may, for example, be implemented in user (or personal) equipment with media content recording capability (e.g., a personal video recorder, a television receiver (or set top box) with video recording capability, a gaming device with video recording capability, a personal computing device (e.g., handheld, notebook, laptop, desktop, etc.) with video recording capability, etc.). The method 100 may, for example, be implementing in user equipment incorporated into a single housing, but may also be implemented in user equipment contained in a plurality of separate housings (e.g., a set top box communicatively coupled to a stand-alone PVR, a television coupled to a personal media database, etc.). Although the following discussion will generally concern the operation of user equipment, it should be realized that any or all aspects of the present invention may also be implemented in non-user equipment (e.g., communication network infrastructure equipment, original media content server equipment, etc.). Accordingly, the scope of various aspects of the present invention should not be limited by characteristics of any particular type of equipment unless explicitly claimed.

The exemplary method 100 may begin executing at step 105. The method 100 may begin executing in response to any of a variety of causes and/or conditions, non-limiting examples of which will now be provided. For example, the exemplary method 100 may begin executing in response to user input. Also for example, the exemplary method 100 may begin executing in response to a timer. Additionally for example, the exemplary method 100 may begin executing in response to a detected event or system condition. For example, the method 100 may execute whenever playback of recorded media content (e.g., media content including embedded advertising content) is detected. Also for example, the method 100 may begin executing in user equipment in response to a command received from a content provider. Further for example, the method 100 may begin executing in response to determining that a particular user is playing back recorded media (e.g., a user for which monitoring has been requested and/or enabled). In general, the method 100 may begin executing in response to any of a variety of causes and/or conditions. Accordingly, the scope of various aspects of the present invention should not be limited by characteristics of any particular causes or conditions unless explicitly claimed.

The exemplary method 100 may, for example at step 110, comprise recording advertising content. Such recording may be performed in any of a variety of manners, non-limiting examples of which will now be presented. For example, step 110 may comprise recording advertising content with recorded programming. For example, a user may utilize a graphical user interface of user equipment to designate programming content for recording (e.g., for immediate recording and/or for recording in the future). As discussed above, such programming content may include embedded advertising content. In such a scenario, the advertising content may be recorded along with the programming content.

In another exemplary scenario, step 110 may comprise recording advertising content separate from programming content. For example, advertising content may be received separately from programming content (e.g., in independent data files and/or data streams, over different communication channels, via different communication networks, from different content sources, etc.). In such a scenario, the user equipment (or other system implementing the method 100) may maintain a database of advertising content that is independent of a database of programming content.

Step 110 may, for example, comprise recording the advertising content in a memory of a same user device that is implementing the method 100. Alternatively, for example, step 110 may comprise recording the advertising content in a recording device (e.g., a stand-alone PVR) that is separate from the device implementing the method 100.

In general, step 110 may comprise recording advertising content (e.g., in user equipment). Accordingly, the scope of various aspects of the present invention should not be limited by characteristics of any particular manner of recording advertising content unless explicitly claimed.

Turning next to step 120, such step may comprise monitoring playback of recorded advertising content (e.g., the advertising content recorded at step 110). Step 120 may comprise performing such monitoring in any of a variety of manners, non-limiting examples of which will now be provided.

For example, step 120 may comprise identifying recorded advertising content. In such a scenario, step 120 may comprise identifying advertising content that is being played back and identifying advertising content that is being skipped by a user. For example, step 120 may comprise identifying advertising content as general advertising content, a specific type of advertising content, advertising for a particular product and/or service, etc. For example, advertising content may be identified by serial number, version number, date, time, source, author, network address, filename, file location, content descriptor, etc.

Step 120 may comprise identifying the recorded advertising content (e.g., advertising content being played back, advertising content being skipped by a user, etc.) in any of a variety of manners. For example, in an exemplary scenario, the advertising content may be explicitly identified by information communicated with the advertising content and stored (e.g., stored with or as part of the advertising content, stored in a data table separate from the stored advertising content, stored with programming content with which the stored advertising content is associated, etc.). Also for example, advertising content identity information may be embedded in media content (e.g., programming content) with which such advertising content is associated. For example, in an exemplary scenario, information identifying advertising content may be included with the data of stored media content in which such advertising content is embedded. In such a scenario, step 120 may comprise identifying the recorded advertising content by analyzing the advertising content identity information that is embedded in the stored media content.

Advertising content itself may include embedded data descriptive of such content. In such a scenario, step 120 may identify advertising content by analyzing such embedded data. Such data may, for example, be included in advertising content metadata, header information, control information, etc. Such data may, for example, be included in a data file for such advertising content and/or communicated with a data stream for such advertising content.

Advertising content may, for example, be described in a template (e.g., an advertising table or other data structure that comprises information identifying advertising content, information indicating when such advertising content is to be presented in relation to programming content, etc.). Such a template may, for example, be provided to user equipment with programming content or separately from programming content. For example, a program-specific advertising template may be received with each program. Also for example, a general advertising template that includes advertising content identity information for a plurality of programs may be received. For example, such a template may be incorporated into (or communicated with) electronic program guide information. In such a scenario, step 120 may comprise identifying the recorded advertising content by, at least in part, analyzing advertising content identity information in the advertising template.

As mentioned previously, advertising content may be identified by header information, metadata, etc., of a file or data stream, where such information may be embedded with such advertising. Such advertising content identifying information may also, for example, be contained in advertising templates. Such information may, for example, include advertising content title, origination time, presentation time, origin date, presentation date, version number, serial number, etc.

Step 120 may also, for example, comprise determining the extent of advertising content playback (e.g., complete playback, partial playback, etc.). For example, step 120 may comprise determining an amount of the recorded advertising content that is played back. For example, step 120 may comprise determining whether a recorded advertisement is played back at normal speed in its entirety. Also for example, step 120 may comprise determining whether at least a particular threshold amount of a recorded advertisement is played back at normal speed (e.g., a threshold of 90%, 75%, 50%, etc.). Step 120 may comprise determining the portion (or percentage) of the recorded advertising content that is played back at normal speed.

Such presentation amount information may, for example, be useful for a number of purposes. For example, such information might be useful in determining whether an advertisement was substantially (if not completely) presented to the user. Such information may, for example, be utilized as part of a billing mechanism (e.g., in determining how much to bill an advertiser, in determining how much to bill an end user, etc.). For example, presentation of an advertisement might be charged to an advertiser if at least a particular minimum percentage of the advertisement is presented to the user. Such billing may also, for example, be graduated, where a premium rate may be charged to an advertiser for complete normal speed playback of an advertisement, a reduced rate may be charged to an advertiser when at least half of the advertisement is played back at a normal speed, no rate might be charged to an advertiser when less then half of the advertisement is played back at normal speed, etc.

In another exemplary scenario, step 120 may comprise identifying a particular time window of a recorded advertisement that is played back at normal speed. Such information might, for example, be utilized to determine whether a key portion of advertising content was presented to the user at normal speed (e.g., where information indicating such key portion is included in an advertising content table, where advertising content includes embedded markers indicating key portions of such content, etc.). Such information might also, for example, be utilized to identify a particular point in an advertisement at which users lose interest.

In yet another exemplary scenario, step 120 may comprise determining whether a recorded advertisement is repeated, paused and restarted, rewound and restarted, etc. Such information might, for example, be utilized to identify particular desired advertising content (or portions thereof). Additionally, for example, such information might be utilized to bill advertisers for repeated presentations of advertising content.

As mentioned above, the monitoring performed at step 120 may be utilized to determine whether (or how much) recorded advertising content is presented (e.g., at normal speed). Mere presentation, however, might not provide all information desired with regard to monitoring playback of recorded advertising content. For example, mere playback of a recorded advertisement does not mean that such advertisement is actually experienced by a user. For example, a user might leave the room during commercial breaks. Various aspects of the present invention may be utilized to address such uncertainty.

Step 120 may also, for example, comprise determining whether a user is present in a media presentation area (e.g., a media presentation envelope) during playback of recorded advertising content. For example, step 120 may comprise determining whether a user is located in a viewing area of a television system that is playing back recorded video advertising content. Also for example, step 120 may comprise determining whether a user is located in a hearing area of an audio system that is playing back recorded audio advertising content. Additionally for example, step 120 may comprise determining whether a user is located within a hearing area, but not a viewing area, of an audio/video presentation system when recorded audio/video advertising content is being played back. In such case, a user might at least experience the audio portion of such audio/video advertising content even if such user is outside of the viewing envelope.

Step 120 may comprise determining whether a user is located in a media presentation area (e.g., a viewing envelope and/or a hearing envelope) in any of a variety of manners, non-limiting examples of which will now be presented.

For example, step 120 may comprise determining the presence of a user (e.g., any user) in the viewing area by infrared detection and/or by motion detection. Such infrared detection and/or motion detection may be configured to detect presence in a sensor area that generally overlaps a media presentation envelope (e.g., a viewing and/or hearing envelope). Also for example, in an exemplary scenario in which a pool of potential users is limited, an infrared signature (e.g., signature size) may also be utilized to distinguish between users to identify a particular user.

Also for example, step 120 may comprise determining the presence of a user in the viewing area by analyzing positioning (or location) information associated with the user (e.g., information received from a personal positioning device associated with the user, information received from a positioning system that determines user location, etc.). For example, user equipment (or another system) implementing the method 100 may receive location information from a smart phone carried by the user. Step 120 may then, for example, comprise comparing the location information to a known media presentation envelope (e.g., the area of a media room, an area in which a television screen may be viewed, an area in which sound volume is known or calculated to be above a particular threshold, etc.) to determine whether a user is located in the media presentation envelope. Note that such determination may comprise determining whether any user is located in the media presentation envelope (e.g., by receiving and analyzing positioning information indicating that some user is in the media presentation envelope) and may also comprise determining the specific identify of a user in the media presentation envelope (e.g., by identifying a smart phone associated with a particular user in the media presentation envelope).

Step 120 may also, for example, comprise detecting the presence of a specific identifiable user in the viewing area by detecting any of a variety of user-specific biological signatures (e.g., utilizing voice recognition, heat signature recognition, retinal scanning, facial recognition, palm/fingerprint recognition on a media controller, user interaction characteristics, etc.).

Step 120 may comprise analyzing user presence information in a media presentation envelope to, for example, determine whether any user or a particular user is exposed to a played back recorded advertisement. For example, in an exemplary scenario in which a particular advertisement was originally targeted to a particular user (e.g., a household manager, a sports fan, a child, a women, a man, a person that has expressed interest in a particular type of consumer good or service, etc.), step 120 may comprise determining whether the particular user was in the media presentation envelope when the targeted advertising content was played back.

The results of the previously-discussed monitoring activity may ultimately be retained for local storage and/or analysis, or may (as will be discussed in more detail below with regard to step 130) be communicated to other entities. The results of the previously-discussed monitoring activity may also be analyzed (e.g., locally at user equipment), where the results of such analysis may then be communicated to other entities, or the results of such analysis may determine the information communicated to the other entities. In other words, the communication activities discussed below (e.g., with regard to step 130) may comprise communicating raw monitoring results, communicating the results of analysis concerning such raw monitored results, and/or communicating particular information depending on the results of such analysis. Step 120 may, in addition to monitoring playback of recorded advertising content, also comprise performing such analysis. Non-limiting examples of such analysis will now be presented.

For example, step 120 may comprise tallying total advertising viewing time. For example, step 120 may comprise tracking a total amount of time during which recorded advertising content is played back. Also for example, step 120 may comprise keeping track of a number of times that an entire advertisement is presented at normal playback speed. Additionally, for example, step 120 may comprise tracking the number of times that a particular threshold amount of an advertisement is presented at normal playback speed.

Step 120 may comprise performing such tallying for all advertising in general, for groups of advertisements and/or for particular advertising content. In an exemplary scenario, step 120 may comprise keeping a tally of how many times a particular recorded advertisement has been played back at normal speed. For example, step 120 may comprise maintaining a table comprising particular identified advertising content and respective playback tally information for each identified advertising content.

Step 120 may also, for example, comprise performing such tallying for all users of a media presentation system and/or for particular users of the media presentation system. In an exemplary scenario in which step 120 comprises identifying a particular user that is being exposed to played back advertising content, step 120 may comprise maintaining a respective table for such user, in which such table identifies the advertising content that is played back in its entirety (or substantially played back) to such user.

In another example, step 120 may comprise tallying a total effective commercial presentation time (e.g., in which any user and/or a particular user is located in a media presentation envelope when recorded advertising content is played back). In an exemplary scenario, step 120 may comprise identifying a number of times that a particular recorded advertisement is played back in its entirety (or to an extent greater than a particular minimum portion) while a user is present in a media presentation envelope. In such a manner, step 120 may track the number of times that a specific recorded advertisement is played back and presented to a specific user. In other words, step 120 may also track particular users, for example to determine whether recorded advertising content is ultimately reaching its intended target (or target audience).

Step 120 may, for example, comprise tallying playback time of recorded advertising content (or a portion or percentage thereof). For example, step 120 may comprise keeping track of the total time during which recorded advertising content is presented at normal presentation speed. Such time tracking may, for example, be performed for all recorded advertising, for a particular set of recorded advertising content, for a particular single advertisement, etc.

In another exemplary scenario, step 120 may comprise calculating a portion of the total available recorded advertising content that is played back (or played back during user presence). For example, in an exemplary scenario in which X minutes of advertising content is recorded for a program and the user views only Y (<X) minutes of advertising content, step 120 may comprise calculating the Y/X portion of advertising viewing time (e.g., for immediate communication to another entity, for tabulation, for future analysis and communication, etc.).

In yet another example, step 120 may comprise performing statistical analysis on the results of the above-mentioned monitoring. For example, step 120 may comprise averaging a number of times recorded advertising content (e.g., in general, a particular group of advertisements, a particular advertisement, etc.) is presented and/or skipped.

Also for example, step 120 may comprise statistically analyzing locations in played back advertising content at which user interest is triggered (or lost). For example, a user may initially fast-forward through a commercial, but stop when a particular visual and/or audio feature is presented. Conversely, such analyzing may, for example, comprise statistically analyzing advertising locations in played back advertising at which a user transitions from normal playback to a fast-forward playback or skip. The results of such analysis may, for example, comprise an indication of the average point at which a user loses interest in a particular advertisement, advertising content in general, etc.

Step 120 may comprise forming an advertising profile, where such advertising profile may be formed for a particular media presentation system (or user equipment), for a particular household, for a particular group of users, for a particular user, etc. Such an advertising profile may, for example, be stored and maintained at the system (e.g., user equipment) implementing the method 100 and may be communicated to other entities. Such an advertising profile may, for example, comprise the results of the above-mentioned monitoring and analysis. For example, such advertising profile may be utilized to characterize the presentation history of recorded advertising content.

In general, step 120 may comprise monitoring (and analyzing) playback of recorded advertising content. Accordingly, the scope of various aspects of the present invention should not be limited by characteristics of any particular manner of performing such monitoring and/or analysis unless explicitly claimed.

Turning next to step 130, such step may comprise communicating information indicative of the monitoring and/or analysis performed at step 120 (e.g., raw monitoring results, tabulated monitoring results, analysis results, etc.). Non-limiting examples of such communicating will now be presented.

For example, step 130 may comprise determining the types of information to communicate. Step 130 may comprise performing such information determination in any of a variety of manners. For example, step 130 may comprise determining information to communicate based, at least in part, on a destination for such information. As will be discussed below, step 130 may comprise communicating information indicative of the playback monitoring to any one or more of a variety of different destinations.

Each of such destinations may correspond to a respective information set. For example, each recipient of such information may desire to receive particular types of information concerning the advertising playback monitoring performed at step 120. For example, a first destination might desire information of total advertising playback time, a second destination might desire information of a ratio of played back advertising content to skipped advertising content, a third destination might desire information indicating whether a particular user was exposed to the entirety of a particular advertisement, a fourth destination might desire only information regarding advertisements concerning goods and/or services associated with the fourth destination, a fifth destination might desire information concerning advertisements created by it, etc. In another exemplary scenario, an advertising agency may desire detailed information regarding which portion of a particular advertisement is being viewed, a media programming provider may desire information concerning overall time for which advertising associated with a particular sponsor has been viewed, a commercial enterprise providing a particular good may desire information about whether its advertising content for the particular good has been presented to a particular target user, etc. In such scenarios, step 130 may tailor the information communicated to each destination.

Additionally, there may be particular types of information that are communicated to all destinations. In such a scenario, step 130 may comprise determining to communicate such information to all destinations (e.g., in addition to information customized to respective destinations).

Step 130 may also, for example, comprise determining the format of information to be communicated. For example, step 130 may comprise determining the format of information to be communicated in any of a variety of manners, non-limiting examples of which will now be provided. For example, as mentioned previously, step 130 may comprise communicating the information to one or more different destinations. Step 130 may also comprise communicating the information over one or more different communication networks. Each of such different destinations and/or different communication networks may correspond to particular respective information formats for communication (e.g., message formats, packet formats, data structures within messages, etc.). For example, step 130 may comprise formatting information in a first manner for communication to a programming provider, in a second manner (e.g., different from the first manner) for communication to an advertising agency, in a third manner for communication to a second advertising agency, in a fourth manner for communication to a second content provider over a first communication network, in a fifth manner for communication to the second content provider over a second communication network, in a sixth manner for communication to a provider of a good and/or service being advertised, etc.

Step 130 may comprise determining a format for communicating the information in any of a variety of manners. For example, step 130 may comprise communicating with a desired destination and/or provider of a communication network to identify such an information format. Step 130 may also, for example, comprise analyzing a table (or other data structure) or querying a database to determine a format for a particular destination, a communication network, or a combination of destination and network. Such table (or other data structure) or database may, for example, be local to the system or equipment implementing the method 100 or may, for example, be remote from the system or equipment implementing the method 100 and communicatively coupled thereto.

Also for example, step 130 may comprise determining a format of information to be communicated (and/or the type of information to be communicated) by analyzing information embedded in received advertising content, information embedded in received programming content, information included in a received advertising content table, information included with electronic program guide information, etc. For example, an advertisement may comprise information that identifies the information to be communicated and the manner in which such information is to be communicated. In an exemplary scenario, advertising content may comprise information in a file or data stream header that identifies particular types of playback monitoring information to be communicated, a particular packet format in which to communicate such information, and a communication network address to which such packet is to be communicated.

Note that a plurality of different destinations may require (or recognize) utilization of a same information format. Also for example, there may be a universal format that is utilized (or recognized) by all destinations. There may also, for example, be a particular communication protocol (e.g., a message exchange sequence) that is dedicated to communication of information related to monitored playback of recorded advertising content.

Step 130 may also, for example, comprise communicating the determined information in the determined format to one or more destinations. For example, step 130 may comprise communicating the same information to a plurality of destinations (e.g., over a same communication network or over different respective selected communication networks). Also for example, step 130 may comprise communicating different information related to the same advertising content to a plurality of different respective destinations.

Step 130 may additionally, for example, comprise communicating the information indicative of said monitoring to a user (e.g., to a user whose advertising content playback has been monitored, to a user of a media presentation system of which advertising content playback has been monitored, etc.). For example, step 130 may comprise interacting with a user of the system implementing the method 100 to communicate information indicative of monitored playback of recorded advertising content.

In general, step 130 may comprise communicating information indicative of the monitoring performed at step 120. Accordingly, the scope of various aspects of the present invention should not be limited by characteristics of any particular manner of determining information to communicate, any particular manner of determining how to communicate such information, and/or any particular manner of communicating such information unless explicitly claimed.

Turning next to step 195, such step may comprise performing continued operation. Various non-limiting examples of such continued operation will now be presented. For example, step 195 may comprise returning execution flow of the exemplary method 100 to any of the previously discussed steps (e.g., for additional advertising content recording and/or playback, for additional monitoring and/or analysis of the playback of advertising content, for additional communication of information indicative of monitored playback of advertising content, etc.).

Also for example, step 195 may comprise developing an advertising profile for a user, for a group of users, for a particular media presentation system, for particular user equipment, etc. Such a profile may, for example, comprise information indicative of advertising playback activities for a particular user, group of users, etc. Step 195 may, for example, comprise communicating information of such an advertising profile to various enterprises. For example, advertising content providers may utilize such advertising profile information to identify specific advertising content, types of advertising content, etc., to be communicated to a particular user, group of users, media presentation system, user equipment, etc.

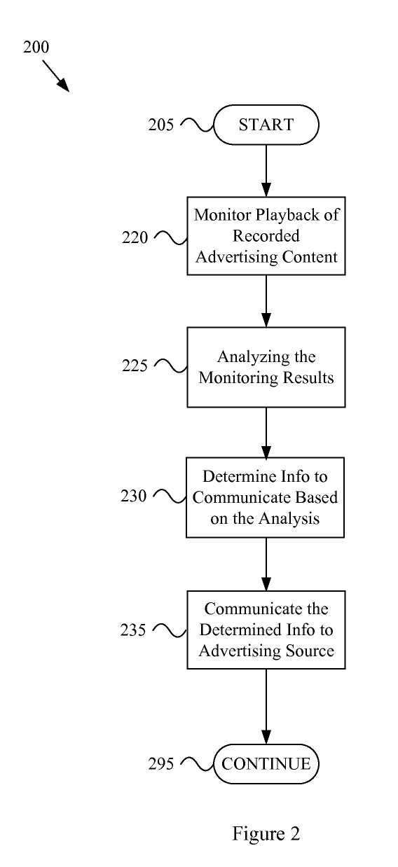

Turning next to FIG. 2, such figure shows a non-limiting exemplary flow diagram of a method 200 for monitoring and reporting presentation of recorded advertising content, in accordance with various aspects of the present invention. The exemplary method 200 may, for example, share any or all characteristics with the exemplary method 100 illustrated in FIG. 1 and discussed previously. Any or all aspects of the exemplary method 200 may, for example, be implemented in user (or personal) equipment with media content recording capability (e.g., a personal video recorder, a television receiver (or set top box) with video recording capability, a gaming device with video recording capability, a personal computing device (e.g., handheld, notebook, laptop, desktop, etc.) with video recording capability, etc.). The method 200 may, for example, be implementing in user equipment incorporated into a single housing, but may also be implemented in user equipment contained in a plurality of separate housings (e.g., a set top box communicatively coupled to a stand-alone PVR, a television coupled to a personal media database, etc.). Although the following discussion will generally concern the operation of user equipment, it should be realized that any or all aspects of the present invention may also be implemented in non-user equipment (e.g., communication network infrastructure equipment, original media content server equipment, etc.). Accordingly, the scope of various aspects of the present invention should not be limited by characteristics of any particular type of equipment unless explicitly claimed.

The exemplary method 200 may begin executing at step 205. Step 205 may share any or all characteristics with step 105 of the exemplary method 100 illustrated in FIG. 1 and discussed previously. Also for example, step 205 (or, for example, step 220) may begin executing at step 195 of the exemplary method 100 illustrated in FIG. 1. Additionally for example, step 205 may comprise recording advertising content (e.g., as discussed previously with regard to step 110).

The exemplary method 200 may, at step 220, comprise monitoring playback of recorded advertising content. Step 220 may, for example, share any or all monitoring characteristics with step 120 of the exemplary method 100 illustrated in FIG. 1 and discussed previously.

The exemplary method 200 may, at step 225, comprise analyzing results of the advertising playback monitoring of step 220. Step 225 may, for example, share any or all analyzing characteristics with step 120 of the exemplary method 100 illustrated in FIG. 1 and discussed previously.

The exemplary method 200 may, at step 230, comprise determining information to communicate (e.g., based on the monitoring performed at step 220 and/or the analysis performed at step 225). Step 230 may, for example, share any or all information determining characteristics (including information formatting characteristics) with step 130 of the exemplary method 100 illustrated in FIG. 1 and discussed previously.

The exemplary method 200 may, at step 235, comprise communicating the information determined at step 230. Step 235 may, for example, share any or all communicating characteristics with step 130 of the exemplary method 100 illustrated in FIG. 1 and discussed previously.

Turning next to step 295, such step generally comprises performing additional operations related to monitoring playback of recorded advertising content. Step 295 may, for example, share any or all characteristics with step 195 of the exemplary method 100 illustrated in FIG. 1 and discussed previously.

Step 295 may, for example, comprise directing execution flow of the exemplary method 200. For example, step 295 may comprise returning execution flow of the exemplary method 200 to any of the previous steps (e.g., for additional monitoring, analyzing, and communicating with regard to recorded advertising content). Also for example, step 295 may comprise performing any other operations discussed herein (e.g., with regard to any of the steps of the exemplary method 100 illustrated in FIG. 1 and discussed below).

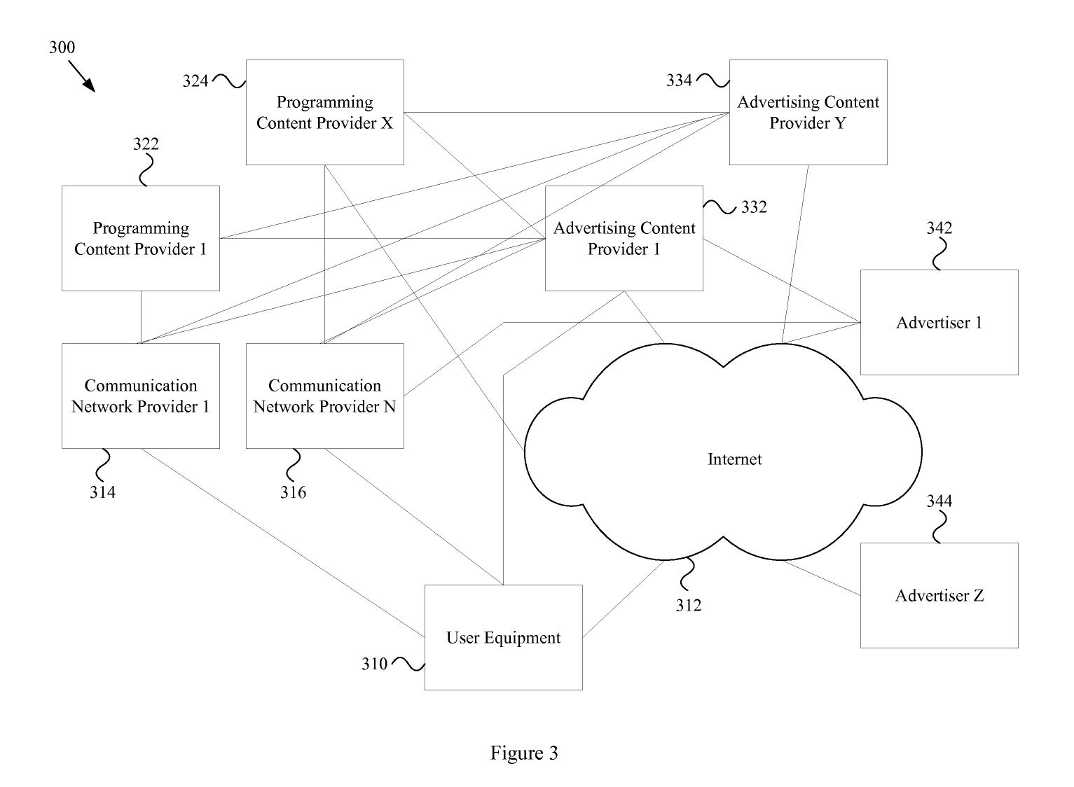

FIG. 3 is a diagram illustrating a video content (e.g., programming and/or advertising video content) distribution and presentation reporting environment 300. The exemplary environment 300 comprises user equipment 310 (e.g., an end-user electronic device with video content recording and playback capability).

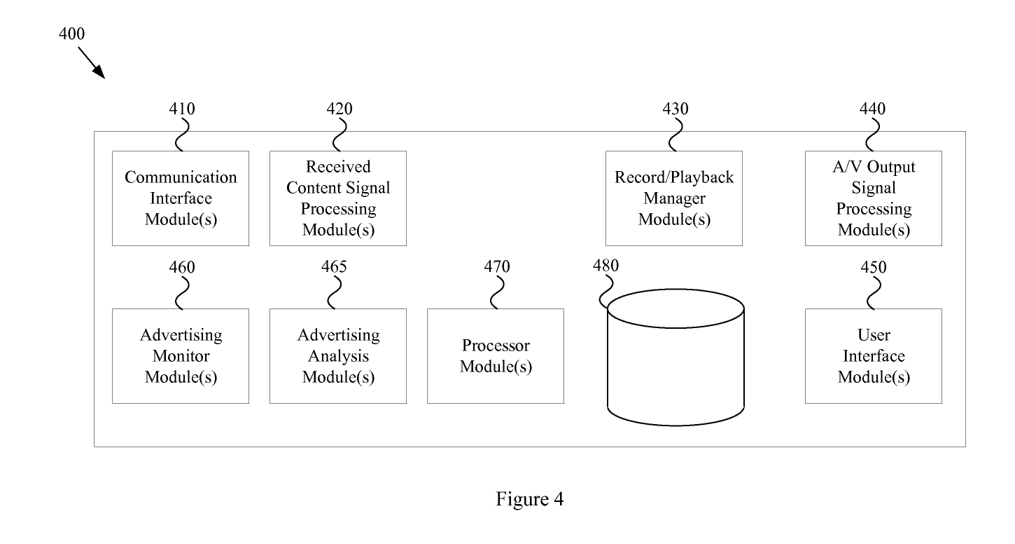

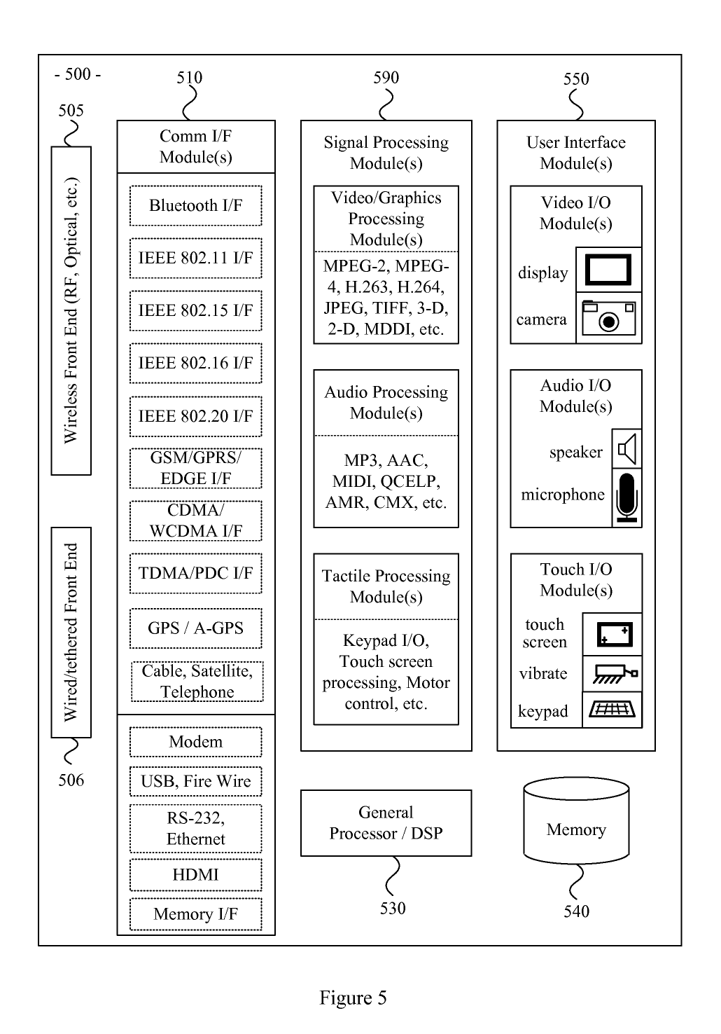

Such user equipment 310 may share any or all characteristics with the user equipment (e.g., a user media presentation system) discussed elsewhere herein, including without limitation the user equipment 400 illustrated in FIG. 4 and/or the user equipment 500 illustrated in FIG. 5. The user equipment 310 may, for example, perform any or all of the functionality discussed previously with regard to the methods 100 and 200 illustrated in FIGS. 1-2 and discussed previously.

The exemplary environment 300 also comprises a plurality of communication networks (or communication network providers). For example, the user equipment 310 is communicatively coupled to a first communication network provider 314 and an N^{th} communication network provider 316. Such communication network providers (314 and 316) may operate to communicatively couple the user equipment 310 to any of a variety of different types of communication networks. For example, such communication network providers (314 and 316) may operate to provide the user equipment 310 access to cable and/or satellite television networks, wired and/or wireless telecommunication networks, wired and/or wireless data networks, wireless networks of various ranges (e.g., PANs, LANs, WANs, MANs, etc.), etc.

The exemplary environment 300 also comprises the Internet 312 (or Internet Service Provider). For example, the user equipment 310 may be communicatively coupled directly to the Internet 312 or via an Internet Service Provider. Note that the user equipment 310 may also, for example, be communicatively coupled to the Internet 312 via the first communication network provider 314 and/or N^{th} communication network provider 316.

The exemplary environment 300 also comprises a plurality of programming content providers (e.g., 1 to X programming providers). For example, the illustrated environment 300 shows a first programming content provider 322 and an X^{th} programming content provider 324. Such programming content providers (322 and 324) may operate to provide programming content (or any video content, including advertising content and/or updated advertising content) to the user equipment 310 via any of the communication networks (or providers) discussed above. A programming provider may, for example, include a television programming provider, a computer network programming provider, a television network or portion thereof (e.g., Fox, NBC, CBS, ABC, ESPN, NFL, HGTV, etc.), etc.

In an exemplary scenario, the first programming content provider 314 may operate to communicate a first television program to the user equipment 310 via the first communication network provider 314. Such a first television program may, for example, comprise embedded first advertising video content that the first programming content provider 314 received from the first advertising content provider 332 and embedded into the first program. Such a first television program may also, for example, comprise information relating the television program to particular advertising content that is not embedded in the television program.

In another exemplary scenario, the X^{th} programming content provider 314 may operate to communicate a second television program to the user equipment 310 via the N^{th} communication network provider 316 and/or via the Internet 312. Such second television program may, for example, alternatively contain no advertising content or contain advertising content received from any or all of the advertising content providers (332 or 334) or advertisers (342 or 344) in the environment 300 or external to the illustrated environment 300.

As mentioned previously, the user equipment 310 may interact with media content providers (e.g., programming content providers, advertising content providers, advertisers, communication service providers, etc.) to, at least in part, obtain advertising content and to communicate information indicative of monitored playback of recorded advertising content. In such an exemplary scenario, the user equipment 310 may operate to communicate with any or all of the communication network providers (314 and 316), the programming content providers (322 and 324), the advertising content providers (332 and 334), and the advertisers (342 and 344).

As mentioned above, advertising video content may be embedded in programming video content. Also for example, as illustrated by various communication pathways in the environment 300, the user equipment 310 may operate to receive advertising content directly from the advertising content providers or advertisers (e.g., enterprises advertising their goods and/or services).

As referred to above, the exemplary environment 300 also, for example, comprise a plurality of advertising content providers (e.g., 1 to Y advertising content providers). For example, the illustrated environment 300 shows a first advertising content provider 332 and a Y^{th} advertising content provider 334. Such advertising content providers (332 and 334) may operate to provide advertising media content (e.g., initial advertising content and/or updated advertising content) to the user equipment 310 via any of the communication networks (or providers) discussed above. Also for example, such advertising providers (332 and 334) may operate to provide advertising video content to the programming content providers (322 and 324) for ultimate communication to the user equipment 310 (e.g., embedded in a television program, radio program, communicated in a data stream independent of data streams communicating media programming, etc.). The user equipment 310 may also (e.g., as discussed previously with regard to steps 130, 230 and 235) communicate information indicative of the monitored playback of recorded advertising content to such advertising providers (332 and 334).

Also, as mentioned above, the exemplary environment 300 also comprises a plurality of advertisers (e.g., 1 to Z advertisers). For example, the illustrated environment 300 shows a first advertiser 342 (e.g., a first commercial enterprise advertising a good or service provided by such first commercial enterprise) and a Z^{th} advertiser 344 (e.g., a Z^{th} commercial enterprise advertising a good or service provided by such Z^{th} commercial enterprise). As illustrated in FIG. 3, such advertisers (342 and 344) may operate to communicate advertising content (or related information), including original and/or updated advertising content, to enterprises that specialize in generating advertising content (e.g., advertising content providers 332 and 334), communicate advertising content (or related information) to programming content providers (e.g., the programming content providers 322 and 324), communicate advertising content (or related information) to communication network providers (or networks) (e.g., the communication network providers 314 and 316, the Internet 312 (or ISP), etc.), and/or communicate advertising content (or related information) directly to the user equipment 310. The user equipment 310 may also (e.g., as discussed previously with regard to steps 130, 230 and 235) communicate information indicative of the monitored playback of recorded advertising content to such advertisers (342 and 344).

In general, the exemplary environment 300 provides a non-limiting illustration of various entities that might or might not be present in any particular media (e.g., video and/or audio) content distribution system. Accordingly, the scope of various aspects of the present invention should not be limited by characteristics of the exemplary environment 300 unless explicitly claimed.

FIG. 4 is a diagram illustrating various non-limiting aspects of exemplary user equipment 400. The user equipment 400 may comprise characteristics of any of a variety of types of user equipment. For example and without limitation, the user equipment 400 may be or comprise an electronic device (or system) with video recording and/or playback capability. For example, the user equipment 400 may comprise a personal video recorder, a television receiver (or set top box, for example cable and/or satellite) with video recording capability, a gaming device with video recording capability, a television with video recording capability, a personal computing device (e.g., handheld, notebook, laptop, desktop, etc.) with video recording capability, a distributed home network comprising communicatively coupled devices that operate to record and/or playback video content, etc. Such user equipment 400 may, for example, be integrated into a single housing or a plurality of housings of a personal media (e.g., video and/or audio) entertainment system. In a configuration comprising a plurality of housings, such user equipment may be co-located or positioned at geographically distinct locations.

The user equipment 400 may, for example, share any or all characteristics with the user equipment 310 of the environment 300 illustrated in FIG. 3 and discussed previously. Also for example, the user equipment 400 (e.g., one or more modules thereof) may, for example, operate to perform any or all functionality discussed previously with regard to the methods 100 and 200 illustrated in FIGS. 1-2 and discussed previously.

The user equipment 400 may, for example, comprise one or more communication interface modules 410 that operate to perform any or all of the communication interface functionality discussed herein. The communication interface module(s) 410 may, for example, operate to communicate over any of a variety of communication media and utilizing any of a variety of communication protocols (e.g., including operating in accordance with various respective protocol layers, for example, PHY, MAC, network, transport, etc.). For example, the communication interface module 410 may be operable to communicate via one or more wired and/or wireless communication ports. The communication interface module(s) 410 may, for example, operate to communicate with one or more communication networks (e.g., cable television networks, satellite television networks, telecommunication networks, the Internet, local area networks, personal area networks, metropolitan area networks, etc.) via which media content (e.g., television program content, advertising video content, radio programming and/or advertising content, etc.) and/or other data (e.g., information regarding the manner in which advertising video content is to be displayed, user information, account information, general data, information regarding monitored playback of recorded advertising content, etc.) is communicated. Also for example, the communication interface module(s) 410 may operate to communicate with local sources of media content (e.g., video and/or audio recorders, receivers, gaming devices, etc.) that may, for example, be external to but communicatively coupled to the user equipment 400. Additionally, for example, the communication interface module(s) 410 may operate to communicate with a controller (e.g., a remote controller) for the user equipment 400 (e.g., directly or via one or more intermediate communication networks).

The exemplary user equipment 400 may also comprise additional communication interface modules, which are not illustrated. Such additional communication interface modules may, for example, share any or all aspects with the communication interface module(s) 410 discussed above.

The exemplary user equipment 400 may comprise one or more received content signal processing modules 420. Such signal processing module(s) 420 may, for example, operate to process received media and/or data content (e.g., programming and/or advertising content, user interface content received via a communication network etc.). Such signal processing module(s) 420 may, for example and without limitation, comprise video decoding modules, transcoding modules that convert encoded content from one code to another, audio processing modules, etc.

The exemplary user equipment 400 may comprise one or more media record/playback manager modules 430. Such module(s) 430 may operate to manage the recording and playback of video content (e.g., program content, advertising content, etc.). Such module(s) 430 may operate to perform any or all of the media recording and/or playback functionality discussed herein (e.g., with regard to steps 110, 120 and 220).

Such media record/playback module(s) 430 may, for example, operate to utilize the user interface module(s) 450 to interact with a user regarding desired recording and playback operation. Such module(s) 430 may, for example, operate to interact with the memory 480 (or with an external memory via the communication interface module(s) 410) for recording media content and/or reading recorded media content. Such module(s) 430 may, for example, operate to interact with the advertisement monitor module(s) 460 which monitors presentation of recorded advertising content. Such module(s) 430 may also, for example, operate to utilize the A/V output signal processing module(s) 440 to process output media content for ultimate presentation to a user.

As mentioned above, the exemplary user equipment 400 may also comprise one or more audio/video output signal processing modules 440. Such A/V output signal processing module(s) 440 may, for example, operate to process audio and/or video information for output to a display and/or speaker device. For example, such module(s) 440 may operate to receive stored media content information from the memory 480 and process such information (e.g., performing decoding, performing decompressing, converting video data into video display driver signals, converting audio data into speaker driver signals, etc.) for output to a user. For example, the A/V output signal processing module(s) 440 may operate to output audio speaker and/or video display driver signals. Also for example, the module(s) 440 may operate to output processed audio and/or video data for further downstream processing (e.g., for ultimate presentation to a user in human-perceivable form).

The exemplary user equipment 400 may also comprise one or more user interface modules 450. The user interface module(s) 450 may generally operate to provide user interface functionality to a user of the user equipment 400. The user interface module(s) 450 may, for example, operate to perform any or all of the user interface functionality discussed herein.

For example, and without limitation, the user interface module(s) 450 may operate to provide for user control of any or all standard user equipment commands (e.g., media recording and/or playback control, for example, record commands, playback commands scheduled recording commands, channel control, on/off control, video input and/or output selection, audio input and/or output selection, programming interaction, interacting with the user regarding the presentation and/or updating of advertising media content before, during and/or after the presentation of the recorded program media content.

The user interface module(s) 450 may, for example, operate to respond to user commands utilizing user interface features disposed on the user equipment 400 (e.g., buttons, etc.) and may also utilize the communication module(s) 410 to communicate with a controller (e.g., a dedicated user equipment remote control, a universal remote control, a cellular telephone, personal computing device, gaming controller, etc.). Further for example, the user interface module(s) 450 may utilize the communication module(s) 410 to communicate with another device external to the user equipment 400 to utilize the user interface features of such external device.

The exemplary user equipment 400 may comprise one or more processors 470. The processor(s) 470 may, for example, comprise a general purpose processor, digital signal processor, application-specific processor, microcontroller, microprocessor, etc. For example, the processor(s) 470 may operate in accordance with software (or firmware) instructions. As mentioned previously, in addition to or in lieu of any or all functionality discussed herein being performed by discrete hardware (e.g., in distinct separate integrated circuits or combined into a single integrated circuit), any or all functionality discussed herein may be performed by a processor executing instructions. For example, though various modules are illustrated as separate blocks or modules in FIG. 4, such illustrative modules, or any portion thereof, may be implemented by the processor(s) 470.

The exemplary user equipment 400 may comprise one or more memories 480. As discussed above, any or all functional aspects discussed herein may be performed by one or more processors executing instructions. Such instructions may, for example, be stored in the one or more memories 480. Such memory 480 may, for example, comprise characteristics of any of a variety of types of memory. For example and without limitation, such memory 480 may comprise one or more memory chips (e.g., ROM, RAM, EPROM, EEPROM, flash memory, one-time-programmable OTP memory, etc.), hard drive memory, CD memory, DVD memory, etc.

Additionally, as discussed previously, the record/playback monitor module(s) 430 may interact with the memory 480 to store media content (e.g., video and/or audio programming and/or advertising content) in the memory 480 and/or retrieve stored media content from the memory 480. In such a scenario, the memory 480 may comprise separate memories or may be partitioned to accommodate stored media content and processor instructions, along with user data and any other type of data (e.g., advertising playback monitoring and/or analysis results, user profile information, user account information, scratch pad data, information regarding data and/or data formats and/or communication network address information for communicating results of advertising playback monitoring and analysis, etc.).

The exemplary user equipment 400 may also comprise one or more advertising monitor modules 460. Such advertisement monitor module(s) 460 may, for example, operate to perform any or all of the recorded advertising content playback monitoring functionality discussed herein.

For example and without limitation, the advertising monitor module(s) 460 may operate to perform any or all functionality discussed previously with regard to step 120 of the exemplary method 100 illustrated in FIG. 1. Also for example, the module(s) 460 may operate to perform any or all functionality discussed previously with regard to step 220 of the exemplary method 200 illustrated in FIG. 2. Various non-limiting examples of such operation will now be presented.

For example, the advertising monitor module(s) 460 may begin performing operations in response to any of a variety of causes or conditions, non-limiting examples of which were discussed previously with regard to step 105 of the method 100 illustrated in FIG. 1.

For example, the advertising monitor module(s) 460 may begin performing operations in response to user input (e.g., as received via the user interface module(s) 450). Also for example, the advertising monitor module(s) 460 may begin performing operations in response to a timer (e.g., as timing information received via the communication interface module(s) 410, as maintained locally by the processor(s) 470, as maintained by the user interface module(s) 450, as maintained locally by dedicated timer circuitry, etc). Additionally for example, the advertising monitor module(s) 460 may begin performing operations in response to a detected event or system condition. For example, the advertising monitor module(s) 460 may begin performing monitoring and/or analysis operations whenever playback of recorded media content (e.g., media content including embedded advertising content) is detected (e.g., detected by the user interface module(s) 450, detected by the media record/playback manager module(s) 430, etc.). Also for example, the advertising monitor module(s) 460 may begin operations in the user equipment 400 in response to a command received from a content provider (e.g., received via the communication interface module(s) 410).

Further for example, the advertising monitor module(s) 460 may begin performing operations in response to determining that a particular user is playing back recorded media (e.g., a user for which monitoring has been requested and/or enabled). Such user identification may, for example, be performed by the advertising monitor module(s) 460 and/or by any of a variety of other modules of the user equipment 400 (e.g., the user interface module(s) 450, the processor 460, etc.). In general, the advertising monitor module(s) 460 may begin performing operations in response to any of a variety of causes and/or conditions. Accordingly, the scope of various aspects of the present invention should not be limited by characteristics of any particular causes or conditions, or by any characteristics of any particular implementing hardware and/or software, unless explicitly claimed.

The user equipment 400 may, as discussed previously, operate to record advertising content. For example, the media record/playback manager module(s) 430 may operate to perform such recording. The media record/playback manager module(s) 430 may operate to perform such recording in any of a variety of manners, non-limiting examples of which will now be presented.

For example, the media record/playback manager module(s) 430 may operate to record advertising content with recorded programming (e.g., in the memory 480, in a memory communicatively coupled to the user equipment 400 via the communication interface module(s) 410, etc.). For example, the user equipment 400 may (e.g., with the user interface module(s) 450) operate to provide a user with a graphical user interface by which a user may designate programming content for recording (e.g., for immediate recording and/or for recording in the future). As discussed above, such programming content may include embedded advertising content. In such a scenario, the advertising content may be recorded along with the programming content (e.g., recorded as a continual serial data stream with advertising content data intermixed with programming content data, recorded as a sequence of media files, etc.).

In another exemplary scenario, the media record/playback manager module(s) 430 may operate to record advertising content separate from programming content. For example, the media record/playback manager module(s) 430 may operate to receive (e.g., via the communication interface module(s) 410) advertising content separately from programming content (e.g., in independent data files and/or data streams, over different communication channels, via different communication networks, from different content sources, etc.). In such a scenario, the user equipment 400 may operate to maintain a database of advertising content that is independent of a database of programming content. In such a scenario, advertising content may, for example, be retrieved from the database and played back during commercial breaks in the recorded programming content being played back.

The media record/playback manager module(s) 430 may, for example, operate to record the advertising content in a memory 480 of the user equipment 400. Alternatively, for example, the media record/playback manager module(s) 430 may operate to record the advertising content in a recording device (e.g., a stand-alone PVR) that is separate from the user equipment 400 (and, for example, communicatively coupled to the user equipment 400 via the communication interface module(s) 410).

In general, the media record/playback manager module(s) 430 may operate to record advertising content (e.g., in the user equipment 400). Accordingly, the scope of various aspects of the present invention should not be limited by characteristics of any particular manner of recording advertising content, or by any particular hardware and/or software that operates to record advertising content, unless explicitly claimed.

The advertising monitor module(s) 460 may, for example, interact with the media record/playback manager module(s) 430 to manage and/or monitor recording of advertising content. For example, as discussed previously, playback of advertising content may be monitored by analyzing a table of advertising information (e.g., a table of advertising content embedded in programming content) to determine when and/or how much recorded advertising content is played back. In such an exemplary scenario, such a table may be received from a source external to the user equipment 400 and/or such a table may be formed by the user equipment 400. The advertising monitor module(s) 460 may, for example, form such a table by monitoring advertising content as it is received and stored by the media record/playback manager module(s) 430.

The advertising monitor module(s) 460 may, for example, operate to monitor playback of recorded advertising content (e.g., the advertising content recorded by the media record/playback manager module(s) 430). For example, the advertising monitor module(s) 430 may operate to perform any or all of the monitoring functionality discussed previously with regard to step 120 of the exemplary method 100 illustrated in FIG. 1 and/or step 220 of the exemplary method 200 illustrated in FIG. 2. The advertising monitor module(s) 460 may operate to perform such monitoring in any of a variety of manners, non-limiting examples of which will now be provided.

For example, the advertising monitor module(s) 460 may operate to identify recorded advertising content. In such a scenario, the advertising monitor module(s) 460 may operate to identify advertising content that is being played back and identify advertising content that is being skipped by a user. For example, the advertising monitor module(s) 460 may operate to identify advertising content as general advertising content, a specific type of advertising content, advertising for a particular product and/or service, etc. For example, advertising content may be identified by serial number, version number, date, time, source, author, network address, filename, file location, content descriptor, etc.

The advertising monitor module(s) 460 may operate to identify the recorded advertising content (e.g., advertising content being played back, advertising content being skipped by a user, etc.) in any of a variety of manners. For example, in an exemplary scenario, the advertising content may be explicitly identified by information communicated with the advertising content and stored (e.g., stored with or as part of the advertising content, stored in a data table separate from the stored advertising content, stored with programming content with which the stored advertising content is associated, etc.). Also for example, advertising content identity information may be embedded in media content (e.g., programming content) with which such advertising content is associated. For example, in an exemplary scenario, information identifying advertising content may be included with the data of stored media content in which such advertising content is embedded. In such a scenario, the advertising monitor module(s) 460 may operate to identify the recorded advertising content by, at least in part, analyzing the advertising content identity information that is embedded in the stored media content. The advertising monitor module(s) 460 may, for example, interact with the media record/playback manager module(s) 430 to determine when played back recorded content corresponds to advertising content (e.g., by identifying data associated with advertising content, by identifying data markers in media content associated with advertising content, etc.).

Advertising content itself may include embedded data descriptive of such content. In such a scenario, the advertising monitor module(s) 460 may identify advertising content by analyzing such embedded data. Such data may, for example, be included in advertising content metadata, header information, control information, etc. Such data may, for example, be included in a data file for such advertising content and/or communicated with a data stream for such advertising content.

Advertising content may, for example, be described in a template (e.g., an advertising table or other data structure that comprises information identifying advertising content, information indicating when such advertising content is to be presented in relation to programming content, etc.). Such a template may, for example, be provided to the user equipment 400 with programming content (e.g., received via the communication interface module(s) 410 with programming content) or separately from programming content (e.g., received via the communication interface module(s) 410 separately from programming content). For example, a program-specific advertising template may be received with each program. Also for example, a general advertising template that includes advertising content identity information for a plurality of programs may be received. For example, such a template may be incorporated into (or communicated with) electronic program guide information. In such a scenario, the advertising monitor module(s) 460 may operate to identify the recorded advertising content by, at least in part, analyzing advertising content identity information in the advertising template.

As mentioned previously, advertising content may be identified by header information, metadata, etc., of a file or data stream, where such information may be embedded with such advertising. Such advertising content identifying information may also, for example, be contained in advertising templates. Such information may, for example, include advertising content title, origination time, presentation time, origin date, presentation date, version number, serial number, etc.

The advertising monitor module(s) 460 may also, for example, operate to determine the extent of advertising content playback (e.g., complete playback, partial playback, etc.). For example, the advertising monitor module(s) 460 may operate to determine an amount of the recorded advertising content that is played back. For example, the advertising monitor module(s) 430 may operate to determine (e.g., via interacting with the video recording/playback manager module(s) 430) whether a recorded advertisement is played back at normal speed in its entirety. Also for example, the advertising monitor module(s) 460 may operate to determine (e.g., via interacting with the video recording/playback manager module(s) 460) whether at least a particular threshold amount of a recorded advertisement is played back at normal speed (e.g., a threshold of 90%, 75%, 50%, etc.). The advertising monitor module(s) 460 may operate to determine the portion (or percentage) of the recorded advertising content that is played back at normal speed.

Such presentation amount information may, for example, be useful for a number of purposes. For example, such information might be useful in determining whether an advertisement was substantially (if not completely) presented to the user. Such information may, for example, be utilized as part of a billing mechanism (e.g., in determining how much to bill an advertiser, in determining how much to bill an end user, etc.). For example, presentation of an advertisement might be charged to an advertiser if at least a particular minimum percentage of the advertisement is presented to the user. Such billing may also, for example, be graduated, where a premium rate may be charged to an advertiser for complete normal speed playback of an advertisement, a reduced rate may be charged to an advertiser when at least half of the advertisement is played back at a normal speed, no rate might be charged to an advertiser when less then half of the advertisement is played back at normal speed, etc.

In another exemplary scenario, the advertising monitor module(s) 460 may operate to identify (e.g., by interacting with the video recording/playback module(s) 430) a particular time window of a recorded advertisement that is played back at normal speed. Such information might, for example, be utilized to determine whether a key portion of advertising content was presented to the user at normal speed (e.g., where information indicating such key portion is included in an advertising content table, where advertising content includes embedded markers indicating key portions of such content, etc.). Such information might also, for example, be utilized to identify a particular point in an advertisement at which users lose interest.

In yet another exemplary scenario, the advertising monitor module(s) 460 may operate to determine whether a recorded advertisement is repeated, paused and restarted, rewound and restarted, etc. Such information might, for example, be utilized to identify particular desired advertising content (or portions thereof). Additionally, for example, such information might be utilized to bill advertisers for repeated presentations of advertising content.

As mentioned above, the monitoring performed by the advertising monitor module(s) 460 may be utilized to determine whether (or how much) recorded advertising content is presented (e.g., at normal speed). Mere presentation, however, might not provide all information desired with regard to monitoring playback of recorded advertising content. For example, mere playback of a recorded advertisement does not mean that such advertisement is actually experienced by a user. For example, a user might leave the room during commercial breaks. Various aspects of the present invention may be utilized to address such uncertainty.

The advertising monitor module(s) 460 may also, for example, operate to determine whether a user is present in a media presentation area (e.g., a media presentation envelope) during playback of recorded advertising content. For example, the advertising monitor module(s) 460 may operate to determine whether a user is located in a viewing area of a television system that is playing back recorded video advertising content. Also for example, the advertising monitor module(s) 460 may operate to determine whether a user is located in a hearing area of an audio system that is playing back recorded audio advertising content. Additionally for example, the advertising monitor module(s) 460 may operate to determine whether a user is located within a hearing area, but not a viewing area, of an audio/video presentation system when recorded audio/video advertising content is being played back. In such case, a user might at least experience the audio portion of such audio/video advertising content even if such user is outside of the viewing envelope.

The advertising monitor module(s) 460 may operate to determine whether a user is located in a media presentation area (e.g., a viewing envelope and/or a hearing envelope) in any of a variety of manners, non-limiting examples of which will now be presented.

For example, the advertising monitor module(s) 460 may operate to determine the presence of a user (e.g., any user) in the viewing area by infrared detection and/or by motion detection. Such infrared detection and/or motion detection may be configured to detect presence in a sensor area that generally overlaps a media presentation envelope (e.g., a viewing and/or hearing envelope). Also for example, in an exemplary scenario in which a pool of potential users is limited, an infrared signature (e.g., signature size) may also be utilized to distinguish between users to identify a particular user.

Also for example, the advertising monitor module(s) 460 may operate to determine the presence of a user in the viewing area by operating to analyze positioning (or location) information associated with the user (e.g., information received from a personal positioning device associated with the user, information received from a positioning system that determines user location, etc.). For example, the user equipment 400 (or another system) may receive location information from a smart phone carried by the user. Such information may, for example, be received via the communication interface module(s) 410. The advertising monitor module(s) 460 may then, for example, compare the location information to a known media presentation envelope (e.g., the area of a media room, an area in which a television screen may be viewed, an area in which sound volume is known or calculated to be above a particular threshold, etc.) to determine whether a user is located in the media presentation envelope. Note that such determination may comprise determining whether any user is located in the media presentation envelope (e.g., by receiving and analyzing positioning information indicating that some user is in the media presentation envelope) and may also comprise determining the specific identify of a user in the media presentation envelope (e.g., by identifying a smart phone associated with a particular user in the media presentation envelope).

The advertising monitor module(s) 460 may also, for example, operate to detect the presence of a specific identifiable user in the viewing area by detecting any of a variety of user-specific biological signatures (e.g., utilizing voice recognition, heat signature recognition, retinal scanning, facial recognition, palm/fingerprint recognition on a media controller, user interaction characteristics, etc.). In such a scenario, the advertising monitoring module(s) 460 may operate to receive such signature information by interfacing with various sensor and/or sensor signal analysis circuitry.

The advertising monitor module(s) 460 may operate to analyze user presence information in a media presentation envelope to, for example, determine whether any user or a particular user is exposed to a played back recorded advertisement. For example, in an exemplary scenario in which a particular advertisement was originally targeted to a particular user (e.g., a household manager, a sports fan, a child, a women, a man, a person that has expressed interest in a particular type of consumer good or service, etc.), the advertising monitor module(s) 460 may operate to determine whether the particular user was in the media presentation envelope when the targeted advertising content was played back.

The results of the previously-discussed monitoring activity may ultimately be retained for local storage (e.g., in the memory 480) and/or analysis (e.g., by the advertising analysis module(s) 465), or may (as will be discussed in more detail below) be communicated to other entities.

In general, the advertising monitor module(s) 460 may operate to monitor the playback of recorded advertising content. Accordingly, the scope of various aspects of the present invention should not be limited by characteristics of any particular manner of performing such monitoring, or of any particular hardware and/or software for performing such monitoring, unless explicitly claimed.

The results of the previously-discussed monitoring activity may also be analyzed (e.g., by one or more advertising analysis module(s) 465 of the user equipment 400), where the results of such analysis may then be communicated to other entities, or the results of such analysis may determine the information communicated to the other entities. For example, the advertising analysis module(s) 465 may operate to perform any or all of the analysis functionality discussed previously with regard to step 120 of FIG. 1 and/or with regard to step 225 of FIG. 2. In other words, the communication activities discussed below may comprise communicating raw monitoring results, communicating the results of analysis concerning such raw monitored results, and/or communicating particular information depending on the results of such analysis. The advertising analysis module(s) 465 may, in addition to monitoring playback of recorded advertising content as performed by the advertising monitor module(s) 460, operate to perform such analysis. Non-limiting examples of such analysis will now be presented.

For example, the advertising analysis module(s) 465 may operate to tally total advertising viewing time. For example, the advertising analysis module(s) 465 may operate to track a total amount of time during which recorded advertising content is played back. Also for example, the advertising analysis module(s) 465 may operate to keep track of a number of times that an entire advertisement is presented at normal playback speed. Additionally, for example, the advertising analysis module(s) 465 may operate to track the number of times that a particular threshold amount of an advertisement is presented at normal playback speed. The advertising analysis module(s) 465 may operate to interact with the media record/playback manager module(s) 430 to perform such tracking.

The advertising analysis module(s) 465 may operate to perform such tallying for all advertising in general, for groups of advertisements and/or for particular advertising content. In an exemplary scenario, the advertising analysis module(s) 465 may operate to keep a tally of how many times a particular recorded advertisement has been played back at normal speed. For example, the advertising analysis module(s) 465 may operate to maintain a table comprising particular identified advertising content and respective playback tally information for each identified advertising content.

The advertising analysis module(s) 465 may also, for example, operate to perform such tallying for all users of a media presentation system and/or for particular users of the media presentation system. In an exemplary scenario in which the advertising monitor module(s) 460 operates to identify a particular user that is being exposed to played back advertising content, the advertising analysis module(s) 465 may operate to maintain a respective table for such user, in which such table identifies the advertising content that is played back in its entirety (or substantially played back) to such user.

In another example, the advertising analysis module(s) 465 may operate to tally a total effective commercial presentation time (e.g., in which any user and/or a particular user is located in a media presentation envelope when recorded advertising content is played back). In an exemplary scenario, the advertising analysis module(s) 465 may operate to identify a number of times that a particular recorded advertisement is played back in its entirety (or to an extent greater than a particular minimum portion) while a user is present in a media presentation envelope. In such a manner, the advertising analysis module(s) 465 may track the number of times that a specific recorded advertisement is played back and presented to a specific user. In other words, the advertising analysis module(s) 465 may also track particular users, for example to determine whether recorded advertising content is ultimately reaching its intended target (or target audience).

The advertising analysis module(s) 465 may, for example, operate to tally playback time of recorded advertising content (or a portion or percentage thereof). For example, the advertising analysis module(s) 465 may operate to keep track of the total time during which recorded advertising content is presented at normal presentation speed. Such time tracking may, for example, be performed for all recorded advertising, for a particular set of recorded advertising content, for a particular single advertisement, etc.

In another exemplary scenario, the advertising analysis module(s) 465 may operate to calculate a portion of the total available recorded advertising content that is played back (or played back during user presence). For example, in an exemplary scenario in which X minutes of advertising content is recorded for a program and the user views only Y (<X) minutes of advertising content, the advertising analysis module(s) 465 may operate to calculate the Y/X portion of advertising viewing time (e.g., for immediate communication to another entity, for tabulation, for future analysis and communication, etc.).

In yet another example, the advertising analysis module(s) 465 may operate to perform statistical analysis on the results of the above-mentioned monitoring. For example, the advertising analysis module(s) 465 may operate to average a number of times recorded advertising content (e.g., in general, a particular group of advertisements, a particular advertisement, etc.) is presented and/or skipped.

Also for example, the advertising analysis module(s) 465 may operate to statistically analyze locations in played back advertising content at which user interest is triggered (or lost). For example, a user may initially fast-forward through a commercial, but stop when a particular visual and/or audio feature is presented. Conversely, such analyzing may, for example, comprise statistically analyzing advertising locations in played back advertising at which a user transitions from normal playback to a fast-forward playback or skip. The results of such analysis may, for example, comprise an indication of the average point at which a user loses interest in a particular advertisement, advertising content in general, etc.

The advertising analysis module(s) 465 may, for example, operate to form an advertising profile, where such advertising profile may be formed for a particular media presentation system (or user equipment), for a particular household, for a particular group of users, for a particular user, etc. Such an advertising profile may, for example, be stored (e.g., in the memory 480) and maintained at the user equipment 400 or other system, and may be communicated to other entities (e.g., utilizing the communication interface module(s) 410). Such an advertising profile may, for example, comprise the results of the above-mentioned monitoring and analysis. For example, such advertising profile may be utilized to characterize the presentation history of recorded advertising content.

In general, the advertising analysis module(s) 465 may operate to analyze the monitored playback of recorded advertising content (e.g., as may be monitored by the advertising monitor module(s) 460). Accordingly, the scope of various aspects of the present invention should not be limited by characteristics of any particular manner of performing such monitoring and/or analysis, or of any particular hardware and/or software for performing such monitoring and/or analysis, unless explicitly claimed.

The exemplary user equipment 400 may also operate to communicate information indicative of the monitoring playback of recorded advertising content. Such information may, for example, be indicative of advertising content monitoring performed by the advertising monitor module(s) 460 and/or analysis of such information performed by the advertising analysis module(s) 465. For example, the user equipment 400 (e.g., the processor module(s) 470 utilizing the communication interface module(s) 410) may operate to perform any or all functionality discussed previously with regard to step 130 of the method 100 illustrated in FIG. 1 and/or with regard to step 235 of the method 200 illustrated in FIG. 2. Non-limiting examples of such operation will now be presented

For example, the processor module(s) 470 may operate to form and transmit one or more messages to one or more content sources (e.g., programming and/or advertising content sources) over the communication link(s) established utilizing the communication interface module(s) 410.

For example, the processor module(s) 470 may operate to determine the types of information to communicate. The processor module(s) 470 may operate to perform such information determination in any of a variety of manners. For example, the processor module(s) 470 may operate to determine information to communicate based, at least in part, on a destination for such information. As will be discussed below, the processor module(s) 470 may operate to communicate information indicative of the playback monitoring to any one or more of a variety of different destinations.

Each of such destinations may correspond to a respective information set. For example, each recipient of such information may desire to receive particular types of information concerning the advertising playback monitoring performed by the advertising monitor module(s) 460 and/or the analysis performed by the advertising analysis module(s) 465. For example, a first destination might desire information of total advertising playback time, a second destination might desire information of a ratio of played back advertising content to skipped advertising content, a third destination might desire information indicating whether a particular user was exposed to the entirety of a particular advertisement, a fourth destination might desire only information regarding advertisements concerning goods and/or services associated with the fourth destination, a fifth destination might desire information concerning advertisements created by it, etc. In another exemplary scenario, an advertising agency may desire detailed information regarding which portion of a particular advertisement is being viewed, a media programming provider may desire information concerning overall time for which advertising associated with a particular sponsor has been viewed, a commercial enterprise providing a particular good may desire information about whether its advertising content for the particular good has been presented to a particular target user, etc. In such scenarios, the processor module(s) 470 may tailor the information communicated to each destination.

Additionally, there may be particular types of information that are communicated to all destinations. In such a scenario, the processor module(s) 470 may operate to determine to communicate such information to all destinations (e.g., in addition to information customized to respective destinations).

The processor module(s) 470 may also, for example, operate to determine the format of information to be communicated. For example, the processor module(s) 470 may operate to determine the format of information to be communicated in any of a variety of manners, non-limiting examples of which will now be provided. For example, as mentioned previously, the processor module(s) 470 may operate to (e.g., utilizing the communication interface module(s) 410) communicate the information to one or more different destinations. The processor module(s) 470 may also operate to communicate the information over one or more different communication networks. Each of such different destinations and/or different communication networks may correspond to particular respective information formats for communication (e.g., message formats, packet formats, data structures within messages, etc.). For example, the processor module(s) 470 may operate to format information in a first manner for communication to a programming provider, in a second manner (e.g., different from the first manner) for communication to an advertising agency, in a third manner for communication to a second advertising agency, in a fourth manner for communication to a second content provider over a first communication network, in a fifth manner for communication to the second content provider over a second communication network, in a sixth manner for communication to a provider of a good and/or service being advertised, etc.

The processor module(s) 470 may operate to determine a format for communicating the information in any of a variety of manners. For example, the processor module(s) 470 may operate to communicate (e.g., utilizing the communication interface module(s) 410) with a desired destination and/or provider of a communication network to identify such an information format. The processor module(s) 470 may also, for example, operate to analyze a table (or other data structure) or query a database to determine a format for a particular destination, a communication network, or a combination of destination and network. Such table (or other data structure) or database may, for example, be local to the user equipment 400 (e.g., stored in the memory 480) or other system, and/or may be remote from the user equipment 400 or other system.

Also for example, the processor module(s) 470 may operate to determine a format of information to be communicated (and/or the type of information to be communicated) by analyzing information embedded in received advertising content, information embedded in received programming content, information included in a received advertising content table, information included with electronic program guide information, etc. For example, an advertisement may comprise information that identifies the information to be communicated and the manner in which such information is to be communicated. In an exemplary scenario, advertising content may comprise information in a file or data stream header that identifies particular types of playback monitoring information to be communicated, a particular packet format in which to communicate such information, and a communication network address to which such packet is to be communicated.

Note that a plurality of different destinations may require (or recognize) utilization of a same information format. Also for example, there may be a universal format that is utilized (or recognized) by all destinations. There may also, for example, be a particular communication protocol (e.g., a message exchange sequence) that is dedicated to communication of information related to monitored playback of recorded advertising content.

The processor module(s) 470 may also, for example, operate to communicate the determined information in the determined format to one or more destinations (e.g., utilizing the communication interface module(s) 410). For example, the processor module(s) 470 may operate to communicate the same information to a plurality of destinations (e.g., over a same communication network or over different respective selected communication networks). Also for example, the processor module(s) 470 may operate to communicate different information related to the same advertising content to a plurality of different respective destinations.

The processor module(s) 470 may additionally, for example, operate to communicate (e.g., via the user interface module(s) 450) the information indicative of said monitoring to a user (e.g., to a user whose advertising content playback has been monitored, to a user of a media presentation system of which advertising content playback has been monitored, etc.). For example, the processor module(s) 470 may operate to interact with a user of the user equipment 400 or other system to communicate information indicative of monitored playback of recorded advertising content.

In general, the processor module(s) 470 may operate to communicate information indicative of the monitoring performed by the advertising monitor module(s) 460 and/or the analysis performed by the advertising analysis module(s) 465. Accordingly, the scope of various aspects of the present invention should not be limited by characteristics of any particular manner of determining information to communicate, any particular manner of determining how to communicate such information, any particular manner of communicating such information unless explicitly claimed, and/or any particular hardware and/or software for performing such functionality.

Continuing the discussion of the processor module(s) 470, such processor module(s) 470 may also operate to perform any of the additional continued functionality discussed previously. For example, the processor module(s) 470 may operate to perform any and all characteristics of the continued processing discussed previously with regard to step 195 of FIG. 1. Non-limiting examples of such continued processing will now be presented.

For example, the processor module(s) 470 may operate to develop an advertising profile for a user, for a group of users, for a particular media presentation system, for particular user equipment 400, etc. Such a profile may, for example, comprise information indicative of advertising playback activities for a particular user, group of users, etc. The processor module(s) 470 may, for example, operate to communicate (e.g., utilizing the communication interface module(s)) information of such an advertising profile to various enterprises. For example, advertising content providers may utilize such advertising profile information to identify specific advertising content, types of advertising content, etc., to be communicated to a particular user, group of users, media presentation system, user equipment, etc.

Turning next to FIG. 5, such figure is a diagram illustrating exemplary modules and/or sub-modules for user equipment 500, in accordance with various aspects of the present invention. The exemplary user equipment 500 may share any or all aspects with any of the user equipment 310 and 400 discussed herein and illustrated in FIGS. 3 and 4. For example, the exemplary user equipment 500 (or various modules thereof) may operate to perform any or all functionality discussed herein with regard to the exemplary method 100 illustrated in FIG. 1 and/or the exemplary method 200 illustrated in FIG. 2. As with the exemplary user equipment 400, the components of the exemplary user equipment 500 may be disposed in a single user device (e.g., a personal video recorder, a television receiver with video recording capability, a gaming device with video recording capability, a personal computing device, etc.).

For example, the user equipment 500 comprises a processor 530. Such a processor 530 may, for example, share any or all characteristics with the processor(s) 470 discussed with regard to FIG. 4. Also for example, the user equipment 500 comprises a memory 540. Such memory 540 may, for example, share any or all characteristics with the memory 480 discussed with regard to FIG. 4.

Also for example, the user equipment 500 may comprise any of a variety of user interface module(s) 550. Such user interface module(s) 550 may, for example, share any or all characteristics with the user interface module(s) 450 discussed previously with regard to FIG. 4. For example and without limitation, the user interface module(s) 550 may comprise: a display device, a camera (for still or moving picture acquisition), a speaker, an earphone (e.g., wired or wireless), a microphone, a video screen (e.g., a touch screen), a vibrating mechanism, a keypad, and/or any of a variety of other user interface devices (e.g., a mouse, a trackball, a touch pad, touch screen, light pen, game controlling device, etc.).

The exemplary user equipment 500 may also, for example, comprise any of a variety of communication modules (505, 506, and 510). Such communication module(s) may, for example, share any or all characteristics with the communication interface module(s) 410 discussed previously with regard to FIG. 4. For example and without limitation, the communication interface module(s) 510 may comprise: a Bluetooth interface module; an IEEE 802.11, 802.15, 802.16 and/or 802.20 module; any of a variety of cellular telecommunication interface modules (e.g., GSM/GPRS/EDGE, CDMA/CDMA2000/1×-EV-DO, WCDMA/HSDPA/HSUPA, TDMA/PDC, WiMAX, etc.); any of a variety of position-related communication interface modules (e.g., GPS, A-GPS, etc.); any of a variety of wired/tethered communication interface modules (e.g., USB, Fire Wire, RS-232, HDMI, Ethernet, wire line and/or cable modem, etc.); any of a variety of communication interface modules related to communicating with external memory devices; etc. The exemplary user equipment 500 is also illustrated as comprising various wired 506 and/or wireless 505 front-end modules that may, for example, be included in the communication interface modules and/or utilized thereby.

The exemplary user equipment 500 may also comprise any of a variety of signal processing module(s) 590. Such signal processing module(s) 590 may share any or all characteristics with modules of the exemplary user equipment 400 that perform signal processing. Such signal processing module(s) 590 may, for example, be utilized to assist in processing various types of information discussed previously (e.g., with regard to sensor processing, position determination, video processing, image processing, audio processing, general user interface information data processing, etc.). For example and without limitation, the signal processing module(s) 590 may comprise: video/graphics processing modules (e.g. MPEG-2, MPEG-4, H.263, H.264, JPEG, TIFF, 3-D, 2-D, MDDI, etc.); audio processing modules (e.g., MP3, AAC, MIDI, QCELP, AMR, CMX, etc.); and/or tactile processing modules (e.g., keypad I/O, touch screen processing, motor control, etc.).

In summary, various aspects of the present invention provide a system and method for monitoring and reporting presentation of recorded advertising content, substantially as shown in and/or described in connection with at least one of the figures, as set forth more completely in the claims. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for monitoring and reporting presentation of recorded advertising content, the method comprising:
in user equipment:
recording advertising content;
monitoring playback of the recorded advertising content; and
communicating information indicative of said monitoring over a communication network.

2. The method of claim 1, wherein said monitoring playback of the recorded advertising content comprises identifying the recorded advertising content.

3. The method of claim 2, wherein said identifying the recorded advertising content comprises analyzing advertising content identity information embedded in media content recorded on the user equipment.

4. The method of claim 2, wherein said identifying the recorded advertising content comprises analyzing advertising content identity information in an advertising template received by the user equipment.

5. The method of claim 1, wherein said monitoring playback of the recorded advertising content comprises determining an amount of the recorded advertising content that is played back.

6. The method of claim 1, wherein said monitoring playback of the recorded advertising content comprises determining whether a recorded advertisement is played back at normal speed in its entirety.

7. The method of claim 1, wherein said monitoring playback of the recorded advertising content comprises determining whether playback of the recorded advertising content is repeated.

8. The method of claim 1, wherein said monitoring playback of the recorded advertising content comprises determining whether a user is present in a media presentation area.

9. The method of claim 1, comprising, in the user equipment:
analyzing results of said monitoring; and
determining the information indicative of said monitoring based, at least in part, on said analyzing.

10. The method of claim 9, wherein said analyzing comprises tallying playback time of at least a portion of the recorded advertising content.

11. The method of claim 1, comprising, in the user equipment:
determining a destination for said communicating; and
determining the information indicative of said monitoring based, at least in part, on the determined destination.

12. The method of claim 1, comprising, in the user equipment:
determining a destination for said communicating; and
determining an information format for the information indicative of said monitoring based, at least in part, on the determined destination.

13. The method of claim 1, wherein said communicating information indicative of said monitoring comprises communicating information indicative of said monitoring to a plurality of destinations.

14. The method of claim 13, wherein said communicating information indicative of said monitoring to a plurality of destinations comprises communicating information indicative of said monitoring to a plurality of destinations over a plurality of different respective communication networks.

15. The method of claim 1, wherein said communicating information indicative of said monitoring comprises selecting a communication network from a plurality of communication networks for said communicating.

16. A system for monitoring and reporting presentation of recorded advertising content in user equipment, the system comprising:
at least one module operable to, at least:
record advertising content;
monitor playback of the recorded advertising content; and
communicate information indicative of said monitoring over a communication network.

17. The system of claim 16, wherein said at least one module is operable to monitor playback of the recorded advertising content by, at least in part, operating to identify the recorded advertising content.

18. The system of claim 17, wherein said at least one module is operable to identify the recorded advertising content by, at least in part, operating to analyze advertising content identity information embedded in media content recorded on the user equipment.

19. The system of claim 17, wherein said at least one module is operable to identify the recorded advertising content by, at least in part, operating to analyze advertising content identity information in an advertising template received by the user equipment.

20. The system of claim 16, wherein said at least one module is operable to monitor playback of the recorded advertising content by, at least in part, operating to determine an amount of the recorded advertising content that is played back.

21. The system of claim 16, wherein said at least one module is operable to monitor playback of the recorded advertising content by, at least in part, operating to determine whether a recorded advertisement is played back at normal speed in its entirety.

22. The system of claim 16, wherein said at least one module is operable to monitor playback of the recorded advertising content by, at least in part, operating to determine whether playback of the recorded advertising content is repeated.

23. The system of claim 16, wherein said at least one module is operable to monitor playback of the recorded advertising content by, at least in part, operating to determine whether a user is present in a media presentation area.

24. The system of claim 16, wherein said at least one module is operable to, at least:
analyze results of said monitoring; and
determine the information indicative of said monitoring based, at least in part, on said analyzing.

25. The system of claim 24, wherein said at least one module is operable to analyze results of said monitoring by, at least in part, operating to tally playback time of at least a portion of the recorded advertising content.

26. The system of claim 16, wherein said at least one module is operable to, at least:
determine a destination for said communicating; and
determine the information indicative of said monitoring based, at least in part, on the determined destination.

27. The system of claim 16, wherein said at least one module is operable to, at least:
determine a destination for said communicating; and
determine an information format for the information indicative of said monitoring based, at least in part, on said determined destination.

28. The system of claim 16, wherein said at least one module is operable to communicate information indicative of said monitoring by, at least in part, operating to communicate information indicative of said monitoring to a plurality of destinations.

29. The system of claim 28, wherein said at least one module is operable to communicate information indicative of said monitoring to a plurality of destinations by, at least in part, operating to communicate information indicative of said monitoring to a plurality of destinations over a plurality of different respective communication networks.

30. The system of claim 16, wherein said at least one module is operable to communicate information indicative of said monitoring by, at least in part, operating to select a communication network from a plurality of communication networks for said communicating.
